(19) United States
(12) Patent Application Publication
(10) Pub. No.: US 2025/0206054 A1
(43) Pub. Date: Jun. 26, 2025

(54) THERMAL PRINTABLE MEDIUM, METHOD FOR PRODUCING THE THERMAL PRINTABLE MEDIUM, USE OF THE THERMAL PRINTABLE MEDIUM AND SYSTEM COMPRISING THERMAL PRINTING DEVICE AND THERMAL PRINTABLE MEDIUM

(71) Applicant: PMG BESITZ GMBH & CO. KG, Pfaffenhofen (DE)

(72) Inventor: Roman PLÖCKL, Pfaffenhofen (DE)

(73) Assignee: PMG BESITZ GMBH & CO. KG, Pfaffenhofen (DE)

(21) Appl. No.: 18/987,207

(22) Filed: Dec. 19, 2024

(30) Foreign Application Priority Data
Dec. 22, 2023 (DE) 102023136606.8

(51) Int. Cl. B41M 5/382; B31D 1/02

(52) U.S. Cl. CPC B41M 5/38214; B31D 1/027; B41M 5/38235

(57) ABSTRACT

A thermal printable medium provides a print substrate and a print color foil. The print substrate has at least one print area. The print color foil covers the print area. The print area is printable by means of heat. The print color foil is fixed to the print substrate outside the print area.

### CROSS-REFERENCE TO RELATED APPLICATIONS

This application claims priority from German Patent Application No. 102023136606.8, filed Dec. 22, 2023; the disclosure of which is incorporated herein by reference in its entirety.

### BACKGROUND OF THE INVENTION

The invention relates to a thermal printable medium that can be printed using a thermal transfer process.

Thermal printing is usually available as direct thermal printing or thermal-transfer printing, each of which is suitable for different applications.

In direct thermal printing, for example, a special thermosensitive paper is passed along a thermal head. The thermal head heats specific positions on the thermosensitive paper, causing said thermosensitive paper to become colored at these points. As the thermosensitive paper is moved along, a complete print image is created. This means that the thermosensitive paper used for direct thermal printing has the coloring properties itself. However, this also means that external influences such as light, heat and moisture can alter the printing result over time. As a result, print media for direct thermal printing have a reduced durability. Examples of printable film materials in the direct thermal printing process are: till rolls. However, other materials are also possible.

In contrast to this, thermal-transfer printing does not use a material that changes color under the influence of heat. Instead, an additional color foil is introduced into the thermal-transfer printer. During the printing process, the film to be printed and the color foil are guided by two conveyor systems so that they lie on top of each other and are passed together along the thermal head. The color material melts on the color foil and adheres to the film to be printed. The film to be printed and the color foil are then separated. Since the film to be printed itself has no coloring properties and subsequent exposure to sunlight or other heat sources will not cause any further discoloration, the printing result using a transfer printing process is more durable than with direct thermal printing. However, the thermal transfer printing process is more expensive and more complex to implement because an additional film is required, and the machine setup involves two materials. In addition, the films and the print head (e.g. thermal head) must be aligned with the conveyor systems with a high degree of precision during setup so that they are guided exactly on top of each other and the desired printing result is achieved. Examples of film materials that can be printed using thermal-transfer printing include: PET, PP, PE films (black, white or colored). Examples of colored films that can be printed using thermal-transfer printing include: black, white or colored TTR color ribbons. However, other materials are also conceivable for thermal-transfer printing.

Thus, both printing processes have advantages and disadvantages. The present invention therefore has the task of creating a thermal printable medium that combines the advantages of the direct thermal printing process with the advantages of the thermal-transfer process.

### SUMMARY OF THE INVENTION

This object is solved by the thermal printable medium with the features of claim 1, the method for producing a thermal printable medium with the features of claim 7, the use of the thermal printable medium with the features of claim 10 and the system for printing the thermal printable medium with the features of claim 11. Further advantageous embodiments and further developments are the subject of the following claims.

A thermal printable medium comprises a print substrate and a print color foil. The print substrate has at least one print area. The print color foil covers the print area. The print area is printable by means of heat. The print color foil is fixed to the print substrate outside the print area.

According to one aspect of the present invention, the print color foil is fixed to the print substrate with an adhesive.

According to one aspect of the present invention, the print substrate comprises a carrier material and an upper material. The carrier material and the upper material are joined to one another and the upper material comprises the print area and is detachable from the carrier material. The upper material may be a label.

According to one aspect of the present invention, the print substrate has a tape-like form, with a plurality of print areas being provided.

According to another aspect of the present invention, the thermal printable medium is in roll form.

The manufacturing of the thermal printable medium comprises providing the print substrate, providing the print color foil and fixing of the print color foil on the print substrate.

According to one aspect of the present invention, the manufacturing also comprises the division of the print substrate into a plurality of print areas.

According to one aspect of the present invention, the manufacturing also comprises the application of the adhesive to the print substrate and/or the print color foil.

The thermal printable medium is used for printing with a thermal transfer printing device or printing with a direct thermal printing device. The present invention thus also represents a system that comprises the thermal printable medium and the thermal transfer printing device or the direct thermal printing device.

### BRIEF DESCRIPTION OF THE DRAWINGS

FIG. 1 shows a thermal printable medium according to a first embodiment and a cross-section of the thermal printable medium;

FIG. 2 shows a thermal printable medium according to a second embodiment;

FIG. 3 shows a step in a manufacturing method for the thermal printable medium;

FIG. 4 shows a further step of the manufacturing method for the thermal printable medium;

FIG. 5 shows a further step of the manufacturing method for the thermal printable medium;

FIG. 6 shows an alternative manufacturing method for a thermal printable medium according to a third embodiment and a cross section thereof;

FIG. 7 shows a use of the thermal printable medium and a system comprising the thermal printable medium and a thermal printing device; and

FIG. 8 shows a printed thermal printable medium.

### DETAILED DESCRIPTION OF THE EMBODIMENTS

The embodiments are described below with reference to the drawings.

### First Embodiment

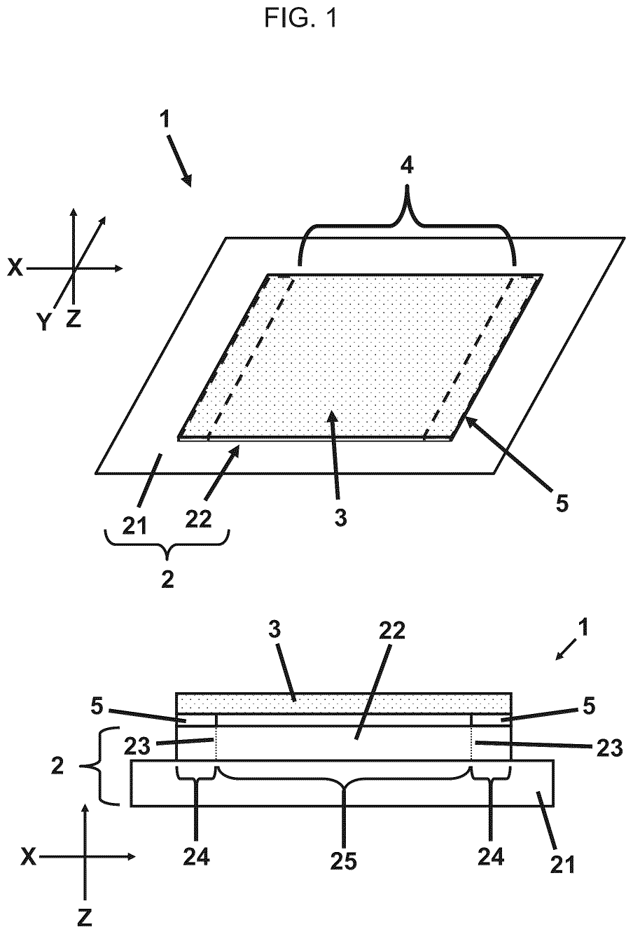

FIG. 1 shows in the upper part a single thermal printable medium 1 according to a first embodiment. The thermal printable medium 1 provides a print substrate 2, a print color foil 3 and an adhesive 5.

The print substrate 2 is rectangular and provides a carrier material 21 and an upper material 22. The upper material 22 is connected to the carrier material 21, wherein the upper material 22 can be peeled off from the carrier material 21. The upper material 22 is, for example, a self-adhesive label that can be dispensed from the carrier material 21. In this case, the upper material 22 can only cover part of the carrier material 21 and can be rectangular.

The print color foil 3 is, for example, a wax, a wax-resin mixture or a resin. The print color foil 3 can release color particles by warming or heating onto a material to which the color particles adhere. According to the first embodiment, the color particles of the print color foil 3 can be transferred to the upper material 22 by means of heat or can be melted there.

The print color foil 3 is fixed to the print substrate 2. According to the first embodiment, an adhesive 5 is used to fix the print color foil 3 to the print substrate 2. The adhesive 5 can, for example, be an adhesive that bonds both to the upper material 22 of the print substrate 2 and to the print color foil 3. The adhesive 5 is partially applied to the upper material 22, so that the upper material 22 is not completely covered with the adhesive 5. The adhesive 5 fixes the print color foil 3 to the print substrate 2, or more precisely to the upper material 22 of the print substrate 2, in such a way that the print color foil 3 at least partially covers the upper material 22 at points where there is no adhesive 5. According to the first embodiment, the adhesive 5 is located on two opposite sides of the rectangular upper material 22 and has a strip shape. The print color foil 3 is provided in a rectangular shape and is fixed to two sides of the rectangular shape on the adhesive 5. This creates a central area where the print color foil 3 covers the upper material 22 but is not fixed to it. The print color foil 3 overlays or spans a print area 4 of the print substrate 2.

An area where the print color foil 3 only covers the upper material 22 but is not fixed to it is referred to as the print area 4. The print area 4 is the area that can be printed on by a thermal printing device 6, since in this area, on the one hand, the print color foil 3 covers the upper material 22 and, on the other hand, the print color foil 3 can be completely removed because it is not fixed within this area. At positions where the adhesive 5 fixes the print color foil 3, the print color foil 3 can be removed, but the color particles adhere to the adhesive 5. A print in this area would thus be unusable because all the color particles in this area would adhere. The print area can therefore be any area on the upper material 22 and is not limited to specific areas, but excludes all areas where printing is unusable due to the adhesive 5.

According to the first embodiment, a punch or perforation 23 is additionally provided in the upper material 22. This divides the upper material 22 into three sections. Two adhesive sections 24 include the areas with the adhesive 5 and a print area section 25 includes the print area 4.

The cross-section view in FIG. 1 schematically shows the layering of the carrier material 21, the upper material 22 with its adhesive sections 24 and 25, the adhesive 5 and the print color foil 3 in a Z-direction, wherein the thickness of each layer does not correspond to the actual thickness ratios but is purely schematic to illustrate the structure of the thermal printable medium.

### Utilization

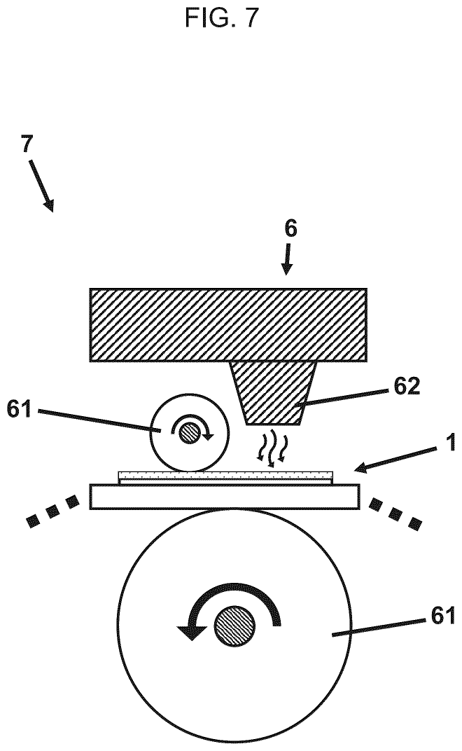

The use of the thermal printable medium 1 according to the first embodiment is described below with reference to FIG. 7.

The thermal printable medium 1 can be inserted or introduced into a thermal printing device 6. The thermal printing device 6 can be, for example, a thermal-transfer printing device or a direct thermal printing device. The thermal printable medium 1 is guided in the thermal printing device 6, for example, over a roller system 61 to a heating element 62 and along the heating element 62. The heating element 62 can, for example, be provided with a plurality of individually controlled heating points. The heating points are controlled in such a way that only those heating points heat up at which printing is to take place in the print area 4 of the upper material 22. At the heated points, the color particles of the print color foil 3 transfer to the upper material 22 or remain stuck there. As the thermal printable medium 1 is guided along the heating element 62, a printing result is gradually obtained on the upper material 22.

After the printing process, the print color foil 3 can be removed from the thermal printable medium 1. The print color foil 3 either detaches from the adhesive 5 or is separated or torn off from the adhesive 5. The carrier material 21, the upper material 22 with the two adhesive sections 24 and the print area section 25 and the adhesive 5 therefore remain with the thermal printable medium 1, whereby a part of the print color foil 3 and color particles of the print color foil 3 may adhere to the adhesive 5.

The punching or perforation 23 in the upper material 22 allows the print area section 25 of the upper material 22 to be subsequently removed from the carrier material 21. Since there is no adhesive 5 in the print area section 25, the only color particles in the print area section 25 are those that were actually printed by the thermal printing device 6. Since the upper material 22 is also a self-adhesive label according to the first embodiment, a printed label can thus be attached or stuck on according to the desired use.

According to the use of the thermal printable medium 1, the thermal printing device 6 and the thermal printable medium 1 form a system 7 for printing a thermal printable medium 1.

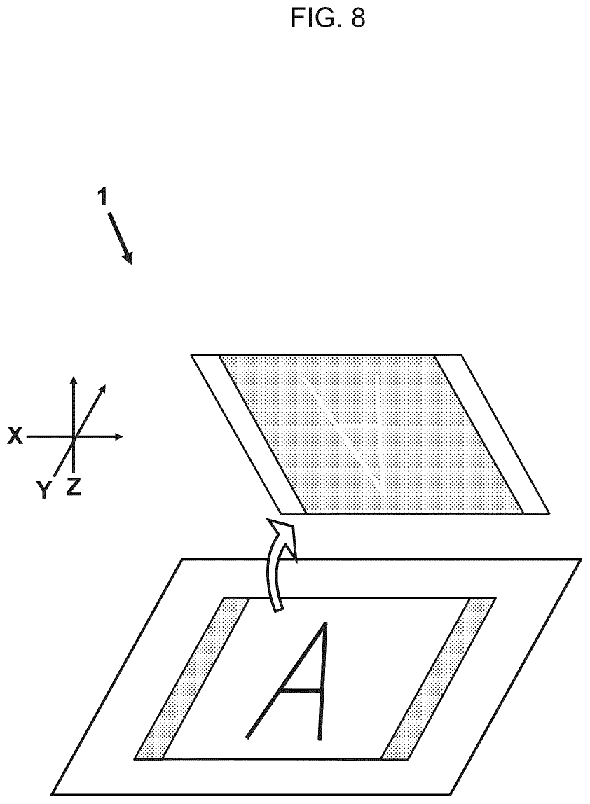

FIG. 8 also shows the thermal printable medium 1 in a printed state, wherein the print color foil 3 has been removed from the print substrate 2. In the state shown in FIG. 8, the upper material 22 can be peeled off or dispensed along the punching or perforation 23. The print color foil 3 also shows where the print color foil 3 was heated and where the color particles of the print color foil 3 have transferred to the upper material 22.

### Second Embodiment

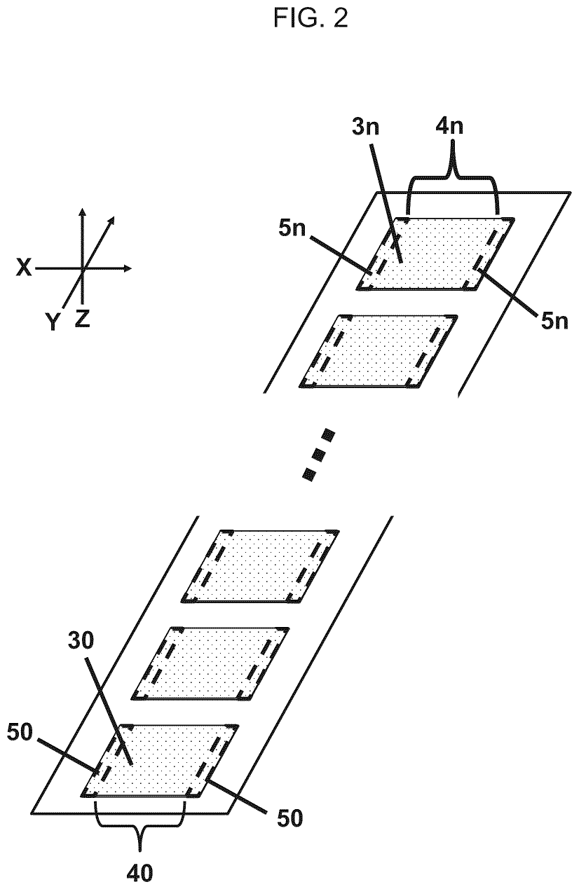

According to a second embodiment, shown in FIG. 2, the thermal printable medium 1 provides a print substrate 2 having a tape-like form. A plurality of print areas 40 to 4n are formed on the print substrate 2.

The print areas 40 to 4n, which are rectangular in shape, are arranged on the print substrate 2 one after the other along a longitudinal extent of the tape-like form of the print substrate 2. The longitudinal extent extends in a Y-direction. Each print area 40 to 4n is separated from another print area 40 to 4n and covered by a separate rectangular print color foil 30 to 3n. Each print color foil 30 to 3n is fixed to the upper material 22 by means of an adhesive 5. The adhesive 5 can be separate for each separate print color foil 30 to 3n or form a continuous section. According to the second embodiment, two strips of adhesives 50 to 5n are provided for each separate print color foil 30 to 3n, which are arranged along the long edge of the tape-like form of the thermal printable medium 1 on opposite sides of the separate print color foils 30 to 3n and also on opposite sides of the print areas 40 to 4n.

The tape-like form of the thermal printable medium 1 allows the thermal printable medium 1 to be continuously introduced into a thermal printing device 6. This enables a continuous printing process without manual reloading after each thermal printable medium 1. In addition, the thermal printable medium 1 can also be rolled up in a space-saving manner and integrated into a roller system 61.

The thermal printable medium 1 according to the second embodiment can be used in the same way as the thermal printable medium 1 according to the first embodiment.

It is also noted that the print areas 40 to 4n do not necessarily have to be separate from each other. The print areas 40 to 4n can, for example, also be connected along a perforation line. The print areas 40 to 4n can also be provided in different shapes and sizes.

### Method

The following describes a method for manufacturing the thermal printable medium 1.

As a first step in the manufacturing method, the print substrate 2 is provided. According to one of the previous embodiments, the print substrate 2 comprises the carrier material 21 and the upper material 22, which are connected to one another. At this point, the carrier material 21 and the print substrate 2 are connected to one another over their entire surface and form, for example, a label material as a raw product.

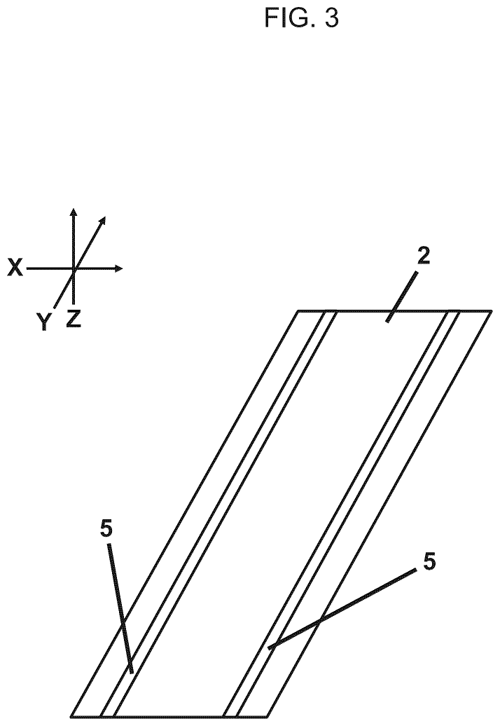

In a second step, the print substrate 2 is provided with an adhesive 5. The adhesive 5 is applied, for example, to two opposite sides along the longitudinal extent of the print substrate 2, as shown in FIG. 3. The adhesive 5 is thus arranged on a left and right side in an X-direction and extends along the Y-direction. The adhesive 5 can be selected as appropriate depending on the materials used. The method of application can also be freely selected. In the previous embodiments, the adhesive 5 is applied in strips. This form can be adapted according to the application.

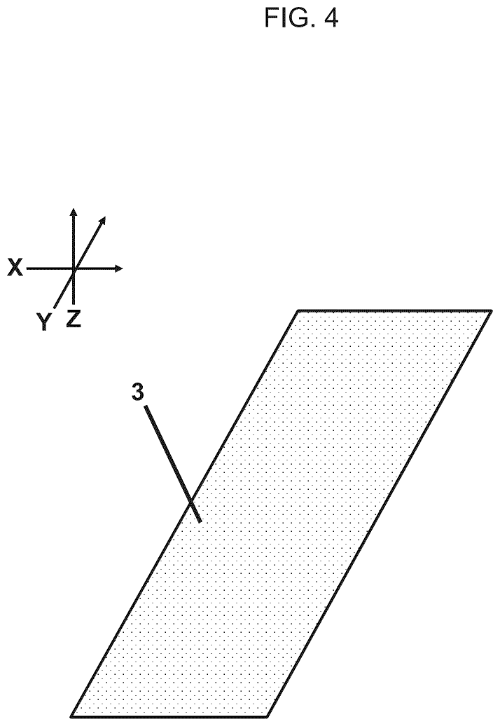

After applying the adhesive 5, the next step, as shown in FIG. 4, is to place the print color foil 3 over the print substrate 2, where it is connected to the print substrate 2 by the adhesive 5. This step already results in a thermal printable medium 1.

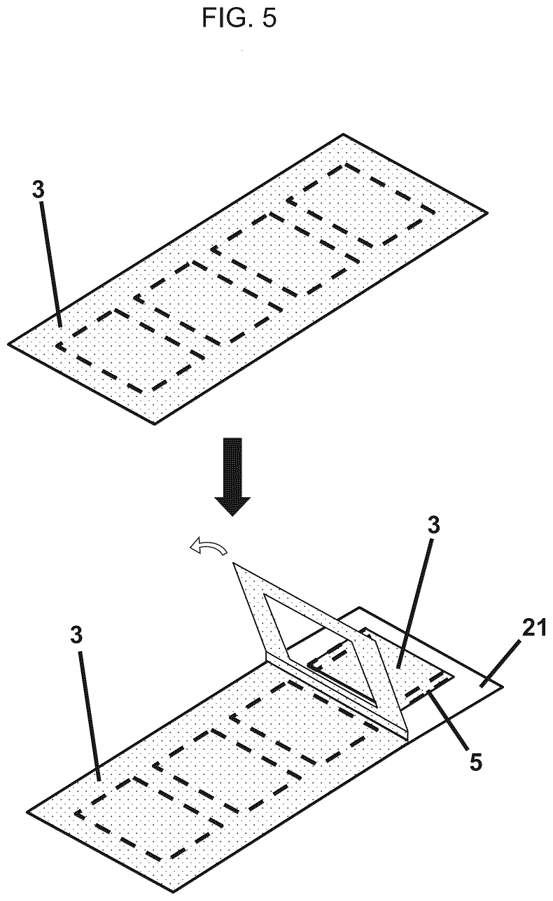

To ensure that the upper material 22 can be easily peeled off, the next step is a punching process in which the upper material 22 and the print color foil 3 are separated into individual sections. In addition, as shown in FIG. 5 above, a plurality of print color foils 30 to 3n, a plurality of print areas 40 to 4n and a plurality of adhesives 50 to 5n are formed. With the removal of the excess print color foil 3, as shown in FIG. 5 below, the carrier material 21 is exposed around the print areas 40 to 4n and the adhesives 50 to 5n. This allows the upper material 22 to be easily peeled off or dispensed, respectively.

However, according to the previous method, it is not necessary for the carrier material 21 to be exposed. The upper material 22 can still be printed on and removed from the carrier material 21 or dispensed despite more difficult handling.

Furthermore, it is possible to modify the method. For example, adhesive 5 can also be applied to the print color foil 3. The print substrate 2 is then fixed to print color foil 3.

Furthermore, the punching can be carried out between the previously described steps for intermediate products. For example, the upper material 22 can first be punched and then the adhesive 5 can be applied. In this case, it is also possible to apply the adhesive 5 to the exposed carrier material 21 instead of to the upper material 22.

### Alternative Method

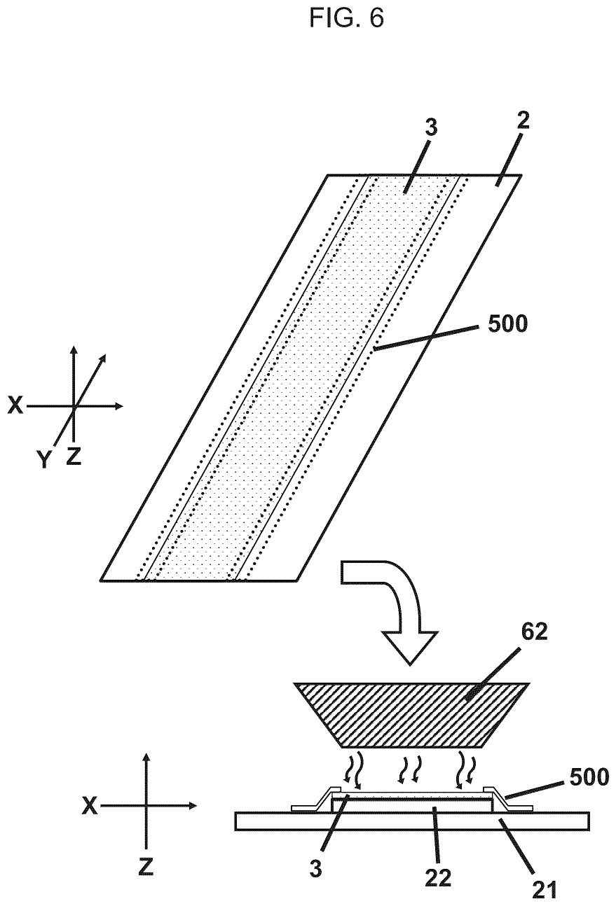

As an alternative to the method described above, a thermal printable medium 1 can be manufactured by a different method according to a third embodiment, which is shown in FIG. 6 at the top.

According to the thermal printable medium 1 of the third embodiment, the print color foil 3 is not fixed on the print substrate 2 by means of an adhesive 5. In this embodiment, the print color foil 3 rests directly on the upper material 22 of the print substrate 2, since no adhesive 5 is applied in between. The print color foil 3 provides an extent according to which the print substrate 2 is exposed from the print color foil 3 at least on two opposite sides.

The print color foil 3 is fixed in place by a fixing section 500. The fixing section 500 is, for example, an adhesive or sticky film. According to the third embodiment, the fixing section 500 is applied in a strip on opposite sides of the longitudinal extent of the print substrate 2, that is, on the left and right side in the X direction. In this case, the fixing section 500 overlaps both the print color foil 3 and the print substrate 2. This is possible because the print color foil 3 provides a smaller area than the print substrate 2, or the print substrate 2 is exposed around the print color foil 3. The fixing section 500 then adheres to the surface of the print color foil 3 and the print substrate 2 from above in the Z-direction.

In other words, this embodiment can be understood as the print color foil 3 being fixed to the print substrate 2 with an adhesive tape. As shown in FIG. 6 at the bottom, the area between the fixing sections 500 is printable by a thermal printing device 6. In the case where the fixing section 500 is thin enough, the fixing section 500 may also extend into or cover the print area 4, provided that the heat generated for printing with the print color foil 3 is sufficient through the fixing section 500.

The thermal printable medium 1 according to the third embodiment can also be punched or perforated to form a plurality of print areas 40 to 4n according to the second embodiment.

Furthermore, the thermal printable medium 1 according to the third embodiment can also be used like the thermal printable media 1 of the first and second embodiment.

### Advantages

The thermal printable medium 1 according to the embodiments described above provides the following advantages.

The print color foil 3 is fixed on the print substrate 2. The thermal printable medium 1 is thus a printable medium with the integrated print color foil 3. This makes it possible to use the thermal printable medium 1 independently of the thermal printing device 6.

The thermal printable medium 1 can be printed using both thermal-transfer and direct thermal printing. When used in a thermal-transfer printing device, a print color foil roll is not necessary, which would first have to be inserted and aligned. The print color foil 3 on the thermal printable medium 1 is already aligned after application, which is why there is less setup work on the machine and the printing process can be started faster.

The direct thermal printing device does not comprise additional print color foil rolls, since the special paper used does not require print color foil 3. However, the special paper is not resistant to external influences. This requires a transfer printing process that can provide more stable results compared to direct thermal printing.

Direct thermal printing devices are usually very compact so that they can be carried on a user's body. This makes it difficult to provide an additional roller system 61 for a print color foil roll. With the thermal printable medium 1 according to the previous embodiments, a thermal-transfer printing can be carried out in a direct thermal printing device. Consequently, the compactness of the direct thermal printing device can be utilized and, at the same time, a printed product, stable and resistant to external influences, can be obtained.

The thermal printable medium 1 according to the previous embodiments is thus a thermal hybrid label that can be universally used in different thermal printing devices 6 with little preparation effort.

### Modifications

The shapes and positions described above are not limited to the shapes and positions. For example, the print substrate 2, the print color foil 3, the print area 4 and the adhesive 5 can be provided in any form and arrangement, as long as the print color foil 3 is fixed to the print substrate 2 in such a way that the print area 4 is covered by the print color foil 3.

The separation of the individual print areas 40 to 4n can be achieved by punching, perforation, cutting or other means that separate the print areas from each other (e.g. also a purely optical separation by means of a marking).

The adhesive 5 can be applied both over the entire surface and in spots. In addition, the adhesive 5 can be selected as any adhesive or bonding agent that can fix the print color foil 3 and the print substrate 2 to one another. In addition, the adhesive 5 and the fixing section 500 can be combined with one another in any way.

The embodiments describe the upper material 22 as a label. However, the upper material 22 can also be something other than a label. Furthermore, the print substrate 2 can consist only of the upper material 22. The upper material 22 does not have to be self-adhesive or have any other form of adhesion.

In the previously described embodiments, the upper material 22 and the print color foil 3 lie flush on top of each other. However, this is not necessary as long as part of the print color foil 3 overlaps the upper material 22, thus creating a printable area.

Furthermore, it is possible to use the thermal printable medium 1 in another thermal printing device. In this case. it is not necessary to use a roller system 61 and a heating clement 62. For example, a heated stamp can also be used.

### LIST OF REFERENCE SIGNS

1 thermal printable medium
2 print substrate
21 carrier material
22 upper material
23 perforation
24 adhesive section
25 print area section
3 print color foil
30 to 3n plurality of print color foils
4 print area
40 to 4n plurality of print areas
5 adhesive
50 to 5n plurality of adhesives
500 fixing section
6 thermal printing device
61 roller system
62 heating element
7 system

1. A thermal printable medium comprising:
a print substrate, and a print color foil, wherein
the print substrate has at least one print area,
the print area is covered by the print color foil and can be printed by means of heat, and
the print color foil is fixed to the print substrate outside the print area.

2. The thermal printable medium according to claim 1, further comprising:
an adhesive for fixing the print color foil to the print substrate.

3. The thermal printable medium according to claim 1, wherein
the print substrate comprises a carrier material and an upper material,
the carrier material and the upper material are bonded to one another,
the upper material comprises the print area and is detachable from the carrier material.

4. The thermal printable medium according to claim 3, wherein
the upper material is a label.

5. The thermal printable medium according to claim 1, wherein
the print substrate comprises a tape-like form, and
a plurality of print areas is provided.

6. The thermal printable medium according to claim 1, wherein
the thermal printable medium comprises a roll form.

7. A method for manufacturing a thermal printable medium according to claim 1, the method comprising:
providing of a print substrate,
providing of a print color foil, and
fixing the print color foil on the print substrate.

8. The method according to claim 7, further comprising:
dividing the print substrate into a plurality of print areas.

9. The method according to claim 7, wherein
an adhesive is applied to the print substrate and/or the print color foil.

10. A use of a thermal printable medium according to claim 1 for printing using a thermal printing device.

11. A system for printing on a thermal printable medium according to claim 1, the system comprising:
a thermal printing device and
the thermal printable medium.
